(19) United States
(12) Patent Application Publication
(10) Pub. No.: US 2015/0136257 A1
(43) Pub. Date: May 21, 2015

(54) Control Valve Structure for a Faucet

(71) Applicant: Sen-Tien Shih, Changhua City (TW)

(72) Inventor: Sen-Tien Shih, Changhua City (TW)

(21) Appl. No.: 14/081,270

(22) Filed: Nov. 15, 2013

(51) Int. Cl. F16K 11/00; F16K 1/46; F16K 5/04; F16K 11/20; F16K 15/18

(52) U.S. Cl. CPC F16K 19/006; F16K 11/207; F16K 15/188; F16K 5/0485; F16K 5/0478; F16K 1/46
USPC 137/603

(57) ABSTRACT

A control valve structure for a faucet contains two controlling valves, each including: a fitting sleeve having a receiving space, an inlet, a sealing element, and at least one first seal ring, between the at least one first seal ring and the fitting sleeve being defined a plurality of outlets; a stem inserted into the fitting sleeve and including a connecting segment, a closing segment, an external screwing portion, at least one second seal ring; a covering member including a first cap element, and a second cap element. A large-diameter disc of the first cap element has a coupling slot with first inner threads, a small-diameter disc of the first cap element has a screw orifice with second inner threads, the second cap element is fitted on the first cap element and has a through hole smaller than that of the screw orifice.

### BACKGROUND OF THE INVENTION

1. Field of the Invention

The present invention relates to a control valve, and more particularly to a control valve structure for a faucet which is produced and is worked easily.

2. Description of the Prior Art

A conventional faucet contains a body in which at least one control valve is disposed, the least one control valve has a handle mounted thereon so that when the handle is rotated to drive the at least one control valve, the faucet is turned on/off and its water supply is adjusted.

With reference to FIGS. 1-3, a convention faucet contains a body 1, two control valves 2, and two handles 3, wherein the body 1 has two chambers 11, and each chamber 11 has an opening 111, outer threads 112 formed around an peripheral side of the opening 111, an inlet channel 12 connected with a bottom end of each chamber 11, and an outlet channel 13 coupled with one side of each chamber 11. Each control valve 2 has a fitting sleeve 21, a stem 22, and a covering member 23. The fitting sleeve 21 is hollow and is mounted in each chamber 11 of the body 1 and has a receiving space 211 and an inlet 212 formed on a bottom end thereof so that the inlet channel 12 of the body 1 communicates with the receiving space 211 of the fitting sleeve 21 via the inlet 212. The fitting sleeve 21 has a first sealing washer 213 formed on an outer peripheral side of a bottom end thereof so as to stop water between the bottom end of the fitting sleeve 21 and the bottom end of each chamber 11. The fitting sleeve 21 also has inner threads 214 arranged around an inner peripheral side thereof and a plurality of outlets 215 defined thereon between the inner threads 214 and the inlet 212, such that the outlet channel 13 of the body 1 communicates with the receiving space 211 of the fitting sleeve 21 via the plurality of outlets 215. The stem 22 is inserted into the fitting sleeve 21 and has a coupling segment 221 located on an outer peripheral side thereof and a closing segment 222 located in the fitting sleeve 22. Between the coupling segment 221 and the closing segment 222 of the stem 22 is defined an external screwing section 223 for screwing with the inner threads 214 of the fitting sleeve 21. In addition, between the coupling segment 221 and the closing segment 222 of the stem 22 are fitted two seal rings 224. The closing segment 222 of the stem 22 has a groove 225 for receiving a check valve 226. The covering member 23 has a slot 231 with an internal screwing portion 2311 formed on a first end thereof and a through hole 232 defined on a central position of a second end thereof and passing through the slot 231. The slot 231 has a second sealing washer 2312 fitted thereon, the internal screwing portion 2311 of the slot 231 screws with the outer threads 112 of the body 1, such that the second sealing washer 2312 is defined between the covering member 23 and the body 1 to stop water. The through hole 232 is provided to insert the stem 22, and the two seal rings 224 of the stem 22 contact with an inner wall of the through hole 232, each handle 3 is connected with the coupling segment 221 of the stem 22 of each control valve 2.

In use, each handle 3 is rotated to drive the stem 22 of each control valve 2 to rotate, and the stem 22 moves upwardly and downwardly by screwing/unscrewing the external screwing section 223 of the stem 22 with/from the inner threads 214 of the fitting sleeve 21, thereby turning on or off the faucet.

However, after the internal screwing portion 2311 of the covering member 23 is screwed with the outer threads 112 of the body 1, the second sealing washer 2312 is pressed downwardly to close water, so the convention faucet is assembled complicatedly. Furthermore, the inner threads 214 of the fitting sleeve 21 is worked difficultly, and between the fitting sleeve 21 and the body 1 has to define a locking structure, thereby increasing production cost and difficulty.

The present invention has arisen to mitigate and/or obviate the afore-described disadvantages.

### SUMMARY OF THE INVENTION

The primary object of the present invention is to provide a control valve structure for a faucet in which first inner threads of a covering member screw with outer threads of each chamber of a body, so it is unnecessary to press a sealing washer forcefully, and a control valve structure is assembled easily, it is not necessary to form inner threads on an inner peripheral side of a fitting sleeve, thus producing the control valve structure at a lower cost.

Another object of the present invention is to provide a control valve structure for a faucet in which the covering member includes a first cap element and a second cap element, thus working the covering member easily and decreasing working cost and enhancing a manufacture yield of the covering member.

To obtain the above objectives, a control valve structure for a faucet contains two controlling valves, each controlling valve is fixed in each of two chambers of a body, each chamber has an opening formed therein, a bottom end connected with an inlet channel, and one side coupled with an outlet channel. Also, each controlling valve includes: a fitting sleeve, a stem, and a covering member.

The fitting sleeve is hollow and has a receiving space connecting with each chamber of the body and having an inlet defined on a bottom end thereof and communicating with the inlet channel of the body and the receiving space of the fitting sleeve. The fitting sleeve also has a sealing element fitted on a bottom end of an outer peripheral side thereof, the fitting sleeve further has at least one first seal ring fitted on an outer side of a middle section thereof and abutting against an inner peripheral wall of each chamber. Between the at least one first seal ring and the bottom end of the fitting sleeve are defined a plurality of outlets, such that the outlet channel of the body communicates with the receiving space of the fitting sleeve via the plurality of outlets.

The stem is inserted into the fitting sleeve and includes a connecting segment located at the outer peripheral side of the fitting sleeve, a closing segment formed in the fitting sleeve, an external screwing portion arranged around an outer peripheral side of the stem between the connecting segment and the closing segment. The stem also includes at least one second seal ring fitted on the outer peripheral side thereof between the external screwing portion and the closing segment and contacting with the fitting sleeve.

The covering member includes a first cap element and a second cap element, the first cap element has a large-diameter circular disc and a small-diameter circular disc between which is defined a stepped portion. The large-diameter disc has a coupling slot with first inner threads, the small-diameter disc has a screw orifice with second inner threads, and the screw orifice communicates with the coupling slot, the second cap element is fitted on the stepped portion of the first cap element. The second cap element has a through hole with a diameter smaller than that of the screw orifice so that the screw orifice is defined between the coupling slot and the through hole, the first inner threads of the coupling slot screw with the opening of each chamber of the body, and the second inner threads of the screw orifice screw with the external screwing portion of the stem, the stem is inserted into the through hole, such that when the stems of each controlling valve rotates, it rotatably moves to control water supply and to turn on/off a faucet.

### BRIEF DESCRIPTION OF THE DRAWINGS

FIG. 1 is a perspective view showing the assembly of a conventional faucet.

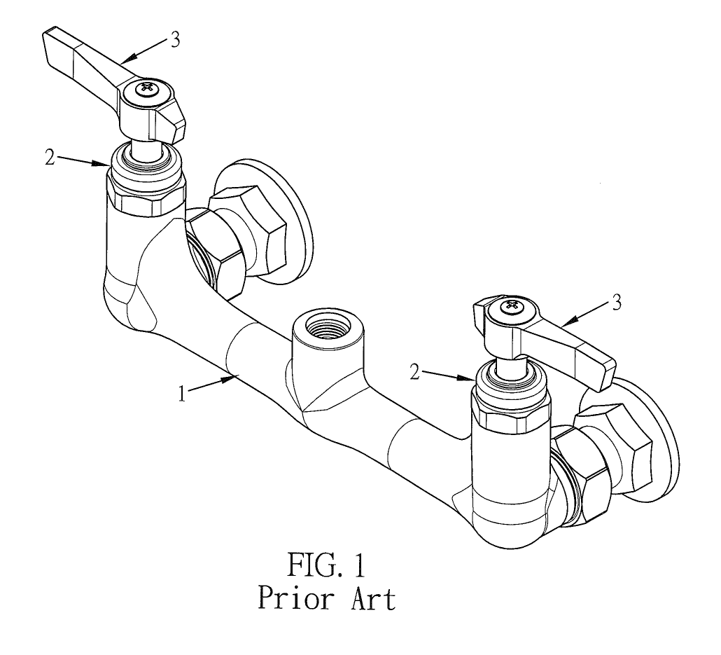

FIG. 2 is a perspective view showing the exploded components of the conventional faucet.

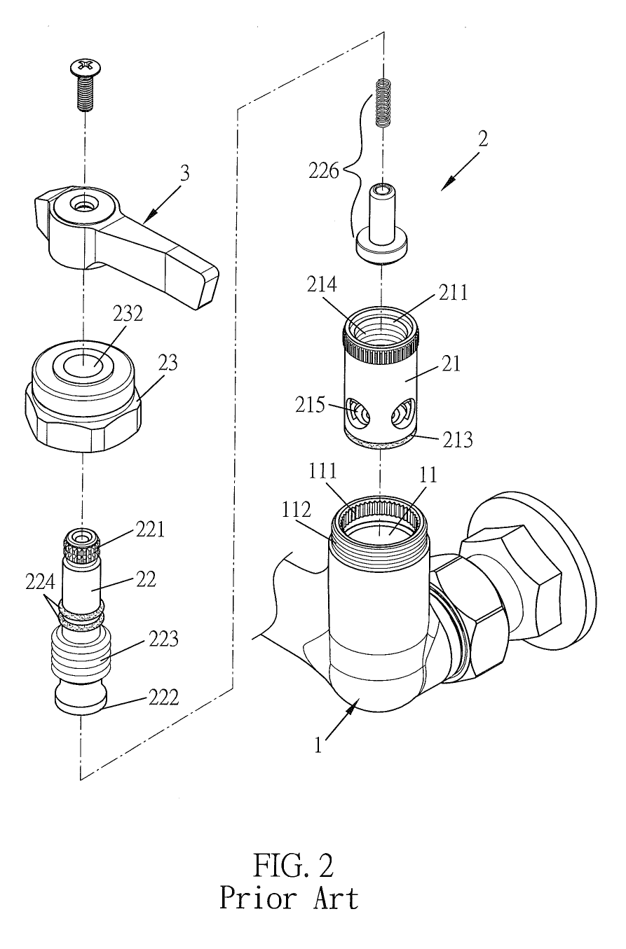

FIG. 3 is a cross sectional view showing the assembly of a part of the conventional faucet.

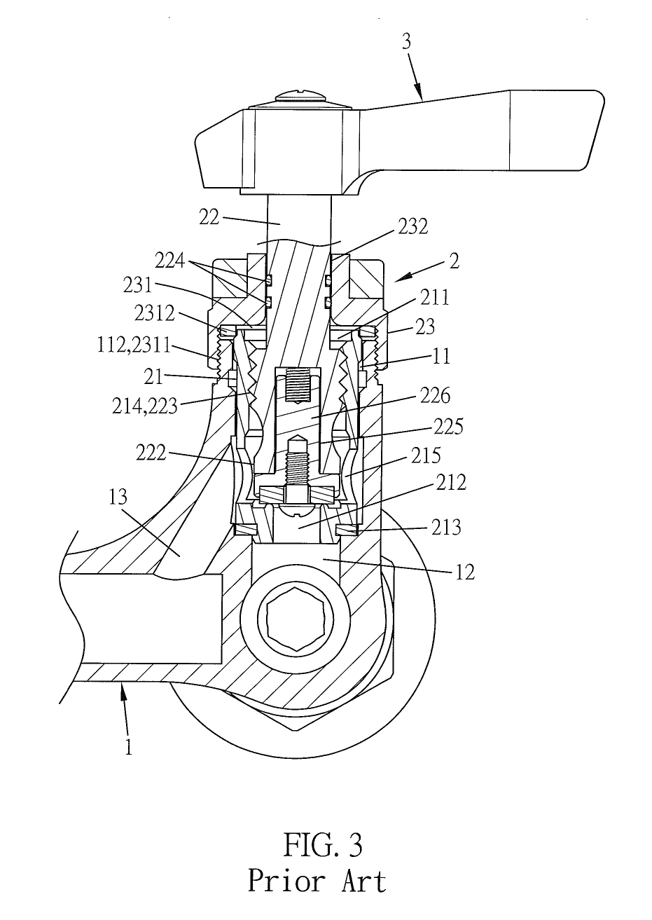

FIG. 4 is a perspective view showing the assembly of a control valve structure for a faucet according to a first embodiment of the present invention.

FIG. 5 is a perspective view showing the assembly of a part of the control valve structure for the faucet according to the first embodiment of the present invention.

FIG. 6 is a cross sectional view showing the assembly and the operation of a part of the control valve structure for the faucet according to the first embodiment of the present invention.

FIG. 7 is a cross sectional view showing the operation of a part of the control valve structure for the faucet according to the first embodiment of the present invention.

FIG. 8 is another cross sectional view showing the operation of a part of the control valve structure for the faucet according to the first embodiment of the present invention.

FIG. 9 is a cross sectional view showing the assembly and the operation of a part of a control valve structure for a faucet according to a second embodiment of the present invention.

FIG. 10 is a cross sectional view showing the operation of a part of a control valve structure for the faucet according to the second embodiment of the present invention.

FIG. 11 is a cross sectional view showing the operation of a part of a control valve structure for a faucet according to a third embodiment of the present invention.

FIG. 12 is a cross sectional view showing the operation of a part of a control valve structure for a faucet according to a fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

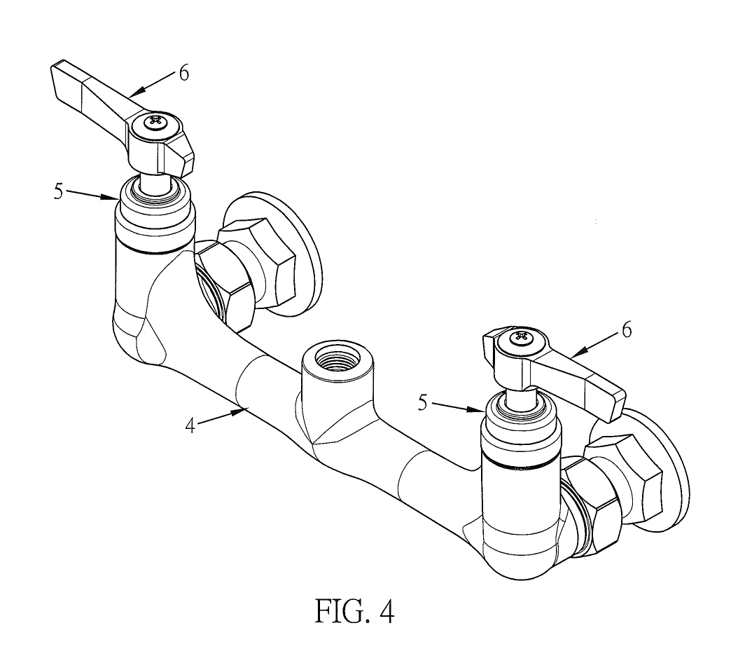

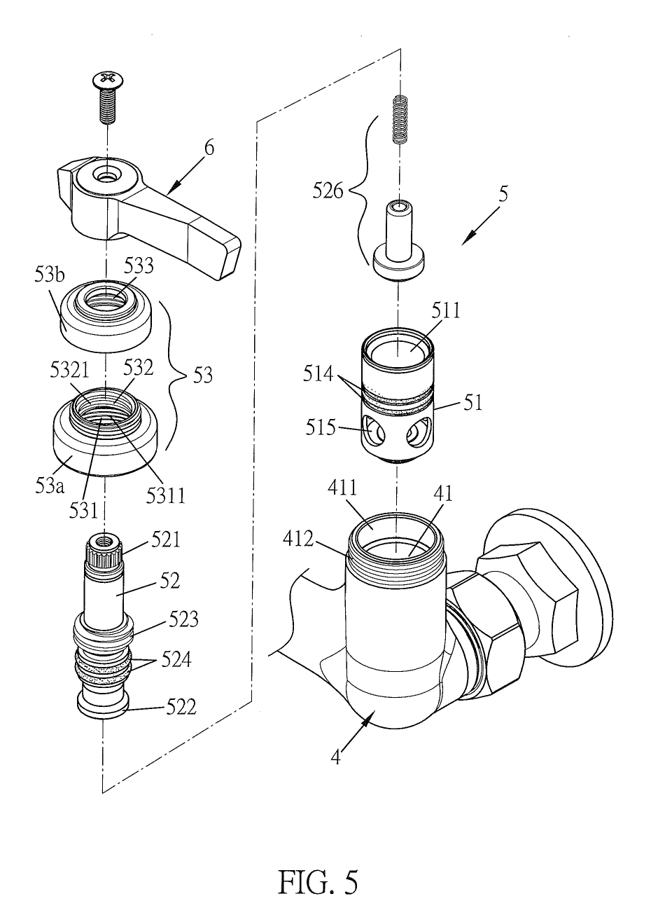

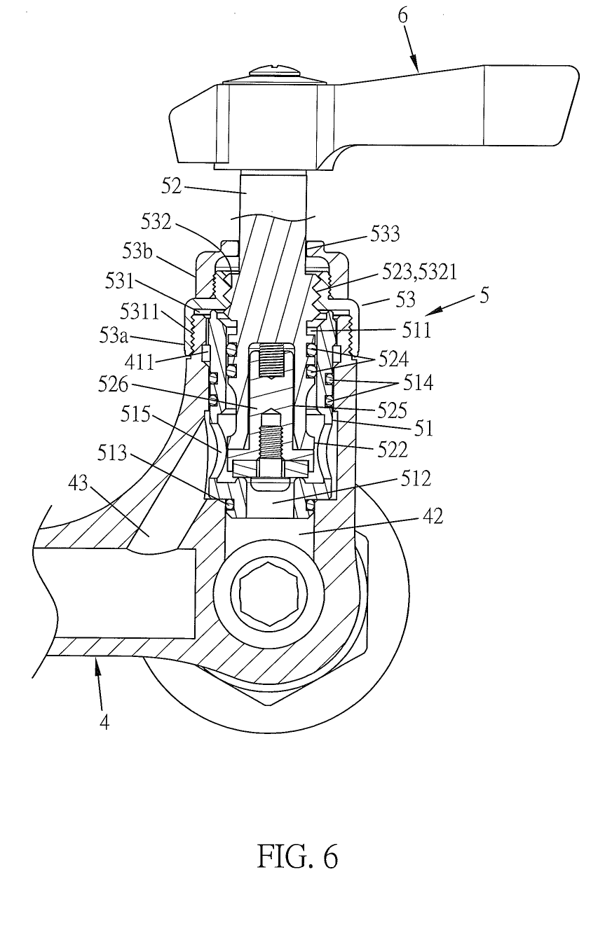

With reference to FIGS. 4 to 6, a faucet according to a preferred embodiment of the present invention comprises: a body 4, two controlling valves 5, and two handles 6, wherein the body 4 includes two chambers 41 defined therein, and each chamber 41 has an opening 411 formed therein and outer threads 412 arranged around an outer peripheral wall thereof. A bottom end of each chamber 41 is connected with an inlet channel 42, and one side of each chamber 41 is coupled with an outlet channel 43. Each controlling valve 5 includes a fitting sleeve 51, a stem 52, and a covering member 53, wherein the fitting sleeve 51 is hollow and has a receiving space 511 connecting with each chamber 41 of the body 4 and has an inlet 512 defined on a bottom end thereof and communicating with the inlet channel 42 of the body 4 and the receiving space 511 of the fitting sleeve 51. The fitting sleeve 51 also has a sealing element 513 fitted on a bottom end of an outer peripheral side thereof so as to stop water between the bottom end of the fitting sleeve 51 and the bottom end of each chamber 41, the fitting sleeve 51 further has at least one first seal ring 514 fitted on an outer side of a middle section thereof and abutting against an inner peripheral wall of each chamber 41 so as to stop water. Between the at least one first seal ring 514 and the bottom end of the fitting sleeve 51 are defined a plurality of outlets 515, such that the outlet channel 43 of the body 4 communicates with the receiving space 511 of the fitting sleeve 51 via the plurality of outlets 515. The stem 52 is inserted into the receiving space 511 of the fitting sleeve 51 and includes a connecting segment 521 located at the outer peripheral side of the fitting sleeve 51, a closing segment 522 formed in the receiving space 511 of the fitting sleeve 51, an external screwing portion 523 arranged around an outer peripheral side of the stem 52 between the connecting segment 521 and the closing segment 522. The stem 52 also includes at least one second seal ring 524 fitted on the outer peripheral side thereof between the external screwing portion 523 and the closing segment 522 and contacting with an inner peripheral side of the fitting sleeve 51 so as to stop water and includes a groove 525 defined on an end surface of the closing segment 522 of the stem 52 so as to receive a check valve 526. The covering member 53 includes a first cap element 53a and a second cap element 53b, the first cap element 53a has a large-diameter circular disc and a small-diameter circular disc between which is defined a stepped portion, wherein the large-diameter disc has a coupling slot 531 with first inner threads 5311, the small-diameter disc has a screw orifice 532 with second inner threads 5321, and the screw orifice 532 communicates with the coupling slot 531. The second cap element 53b is fitted on the stepped portion of the first cap element 53a. The second cap element 53b has a through hole 533 with a diameter smaller than that of the screw orifice 532 so that the screw orifice 532 is defined between the coupling slot 531 and the through hole 533, the first inner threads 5311 of the coupling slot 531 screw with the outer threads 412 of the body 4, and the second inner threads 5321 of the screw orifice 532 screw with the external screwing portion 523 of the stem 52, the stem 52 is inserted into the through hole 533 so that when the stems 52 rotates, it rotatably moves upward and downward by rotating the external screwing portion 523 and the second inner threads 5321 of the screw orifice 532, and the two handles 6 are connected with the connecting segment 521 of the stem 52 of each controlling valve 5.

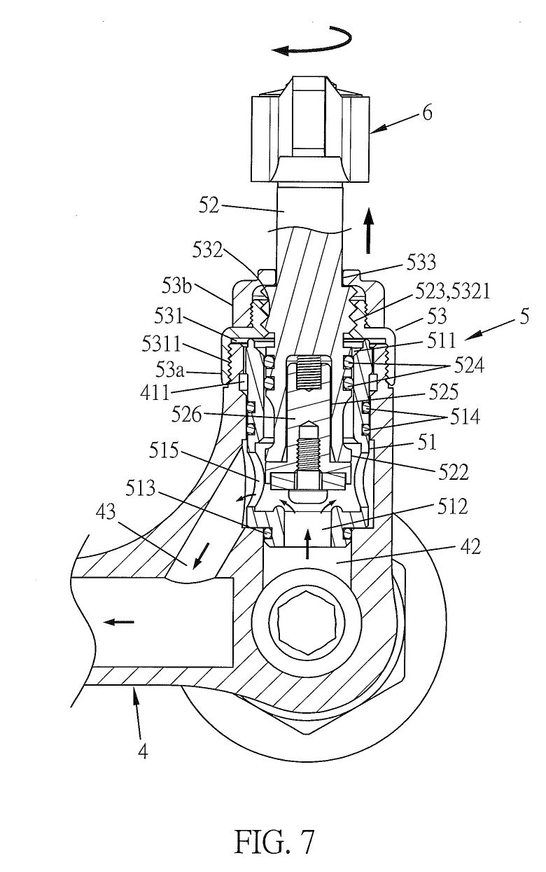

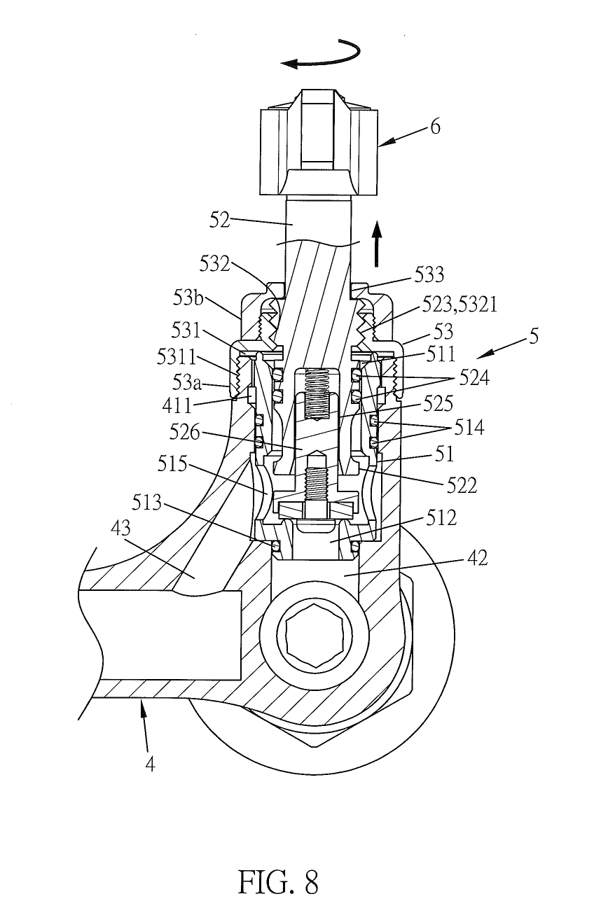

In user, the two handles 6 are rotated to drive the stem 52 of each controlling valve 5 to rotate, and since the first inner threads 5311 of the coupling slot 531 of the covering member 53 screw with the outer threads 412 of the body 4 so that the stem 52 rotates upward and downward by screwing/unscrewing the external screwing portion 523 with/from the second inner threads 5321 of the screw orifice 532 of the covering member 53 as shown in FIGS. 7 and 8, thereby turning on or turning off the controlling control valve structure.

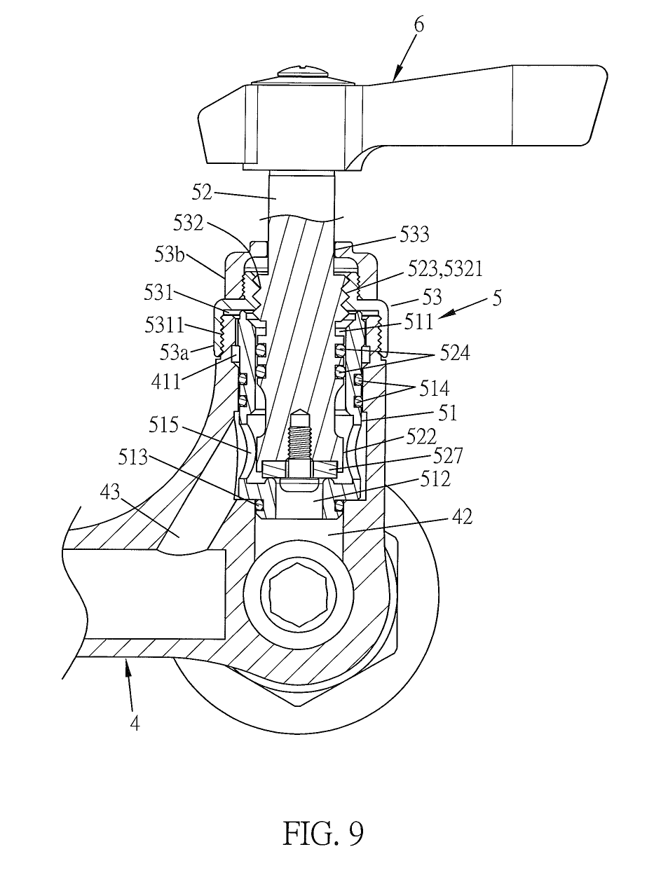

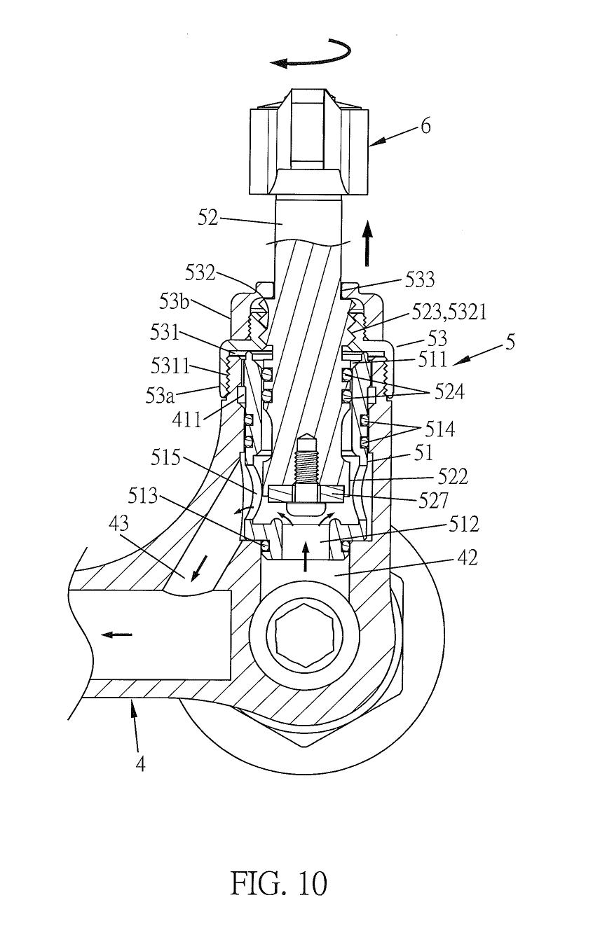

Referring to FIGS. 9 and 10, the control valve structure further comprises a sealing gasket 527 locked on the end surface of the closing segment 522 of the stem 52.

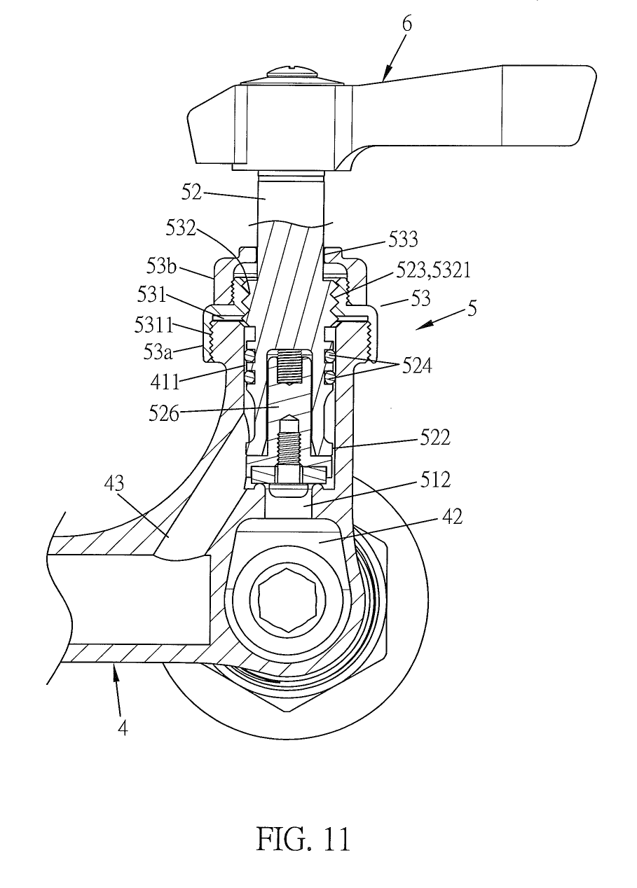

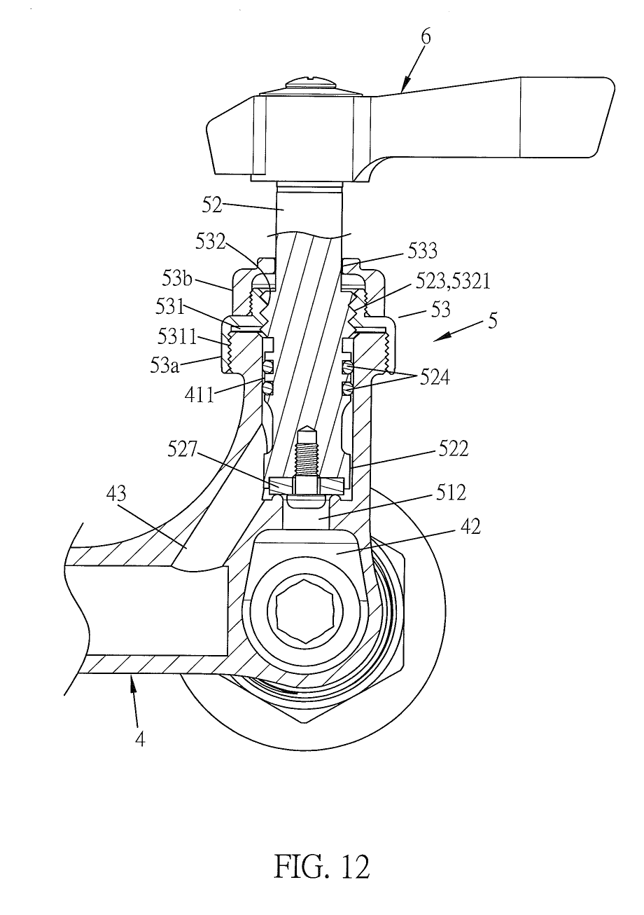

As illustrated in FIG. 11, each chamber 41 of the body 4 is applied to replace the receiving space 511 of the fitting sleeve 51, such that the stem 52 of the controlling valve 5 is fixed in each chamber 41 of the body 4, wherein the connecting segment 521 of the stem 52 of each controlling valve 5 is located on the outer peripheral wall of each chamber 41 of the body 4, the closing segment 522 is located in each chamber 41 of the body 4, the at least one second seal ring 524 fitted on the outer peripheral side of the stem 52 contacts with the inner peripheral wall of each chamber 41 so as to stop water. As desiring to stop water, the check valve 526 of the closing segment 522 of the stem 52 closes the inlet 512 of the fitting sleeve 51 of each controlling valve 5. In addition, as shown in FIG. 12, the sealing gasket 527 of the closing segment 522 of the stem 52 closes the inlet 512 of the fitting sleeve 51 of each controlling valve 5.

Accordingly, the fitting sleeve 51 has the at least one first seal ring 514 fitted on the outer side thereof and abutting against the inner peripheral wall of each chamber 41, the stem 52 includes the at least one second seal ring 524 fitted on the outer peripheral side thereof so as to contact with the inner peripheral side of the fitting sleeve 51, thereby stopping water. The first inner threads 5311 of the coupling slot 531 screw with the outer threads 412 of the body 4, so it is unnecessary to press a sealing washer forcefully, and the control valve structure is assembled easily. Likewise, it is not necessary to form inner threads on the inner peripheral side of the fitting sleeve 51, thus producing the control valve structure at a lower cost.

Moreover, the covering member 53 includes the first cap element 53a and the second cap element 53b, thus working the covering member 53 easily and decreasing a working cost and enhancing a manufacture yield of the covering member 53.

While we have shown and described various embodiments in accordance with the present invention, it is clear to those skilled in the art that further embodiments may be made without departing from the scope of the present invention.

What is claimed is:

1. A control valve structure for a faucet comprising two controlling valves, each controlling valve being fixed in each of two chambers of a body, each chamber having an opening formed therein, a bottom end connected with an inlet channel, and one side coupled with an outlet channel, each controlling valve including:
a fitting sleeve being hollow and having a receiving space connecting with each chamber of the body and having an inlet defined on a bottom end thereof and communicating with the inlet channel of the body and the receiving space of the fitting sleeve, the fitting sleeve also having a sealing element fitted on a bottom end of an outer peripheral side thereof, the fitting sleeve further having at least one first seal ring fitted on an outer side of a middle section thereof and abutting against an inner peripheral wall of each chamber, between the at least one first seal ring and the bottom end of the fitting sleeve being defined a plurality of outlets, such that the outlet channel of the body communicates with the receiving space of the fitting sleeve via the plurality of outlets;
a stem inserted into the fitting sleeve and including a connecting segment located at the outer peripheral side of the fitting sleeve, a closing segment formed in the fitting sleeve, an external screwing portion arranged around an outer peripheral side of the stem between the connecting segment and the closing segment, the stem also including at least one second seal ring fitted on the outer peripheral side thereof between the external screwing portion and the closing segment and contacting with the fitting sleeve;
a covering member including a first cap element and a second cap element, the first cap element having a large-diameter circular disc and a small-diameter circular disc between which is defined a stepped portion, wherein the large-diameter disc has a coupling slot with first inner threads, the small-diameter disc has a screw orifice with second inner threads, and the screw orifice communicates with the coupling slot, the second cap element is fitted on the stepped portion of the first cap element, the second cap element has a through hole with a diameter smaller than that of the screw orifice so that the screw orifice is defined between the coupling slot and the through hole, the first inner threads of the coupling slot screw with the opening of each chamber of the body, and the second inner threads of the screw orifice screw with the external screwing portion of the stem, the stem is inserted into the through hole, such that when the stems of each controlling valve rotates, it rotatably moves to control water supply and to turn on/off a faucet.

2. The control valve structure for the faucet as claimed in claim 1 wherein the sealing element is a seal ring.

3. The control valve structure for the faucet as claimed in claim 1 wherein the stem includes a groove defined on an end surface of the closing segment thereof so as to receive a check valve.

4. The control valve structure for the faucet as claimed in claim 1, wherein the stem also includes a sealing gasket locked on the end surface of the closing segment thereof.

5. The control valve structure for the faucet as claimed in claim 1, wherein the second cap element is fitted on the stepped portion of the first cap element.

6. A control valve structure for a faucet comprising two controlling valves, each controlling valve being fixed in each of two chambers of a body, each chamber having an opening formed therein, a bottom end connected with an inlet channel, and one side coupled with an outlet channel, each controlling valve including:
a stem inserted into each chamber of the body and including a connecting segment located at an outer peripheral side of each chamber, a closing segment formed in each chamber, an external screwing portion arranged around an outer peripheral side of the stem between the connecting segment and the closing segment, the stem also including at least one second seal ring fitted on the outer peripheral side thereof between the external screwing portion and the closing segment and contacting with each chamber;
a covering member including a first cap element and a second cap element, the first cap element having a large-diameter circular disc and a small-diameter circular disc between which is defined a stepped portion, wherein the large-diameter disc has a coupling slot with first inner threads, the small-diameter disc has a screw orifice with second inner threads, and the screw orifice communicates with the coupling slot, the second cap element is fitted on the stepped portion of the first cap element, the second cap element has a through hole with a diameter smaller than that of the screw orifice so that the screw orifice is defined between the coupling slot and the through hole, the first inner threads of the coupling slot screw with the opening of each chamber of the body, and the second inner threads of the screw orifice screw with the external screwing portion of the stem, the stem is inserted into the through hole, such that when the stems of each controlling valve rotates, it rotatably moves to control water supply and to turn on/off a faucet.

7. The control valve structure for the faucet as claimed in claim 6, wherein the stem includes a groove defined on an end surface of the closing segment thereof so as to receive a check valve.

8. The control valve structure for the faucet as claimed in claim 6, wherein the stem also includes a sealing gasket locked on the end surface of the closing segment thereof.

9. The control valve structure for the faucet as claimed in claim 6, wherein the second cap element is fitted on the stepped portion of the first cap element.
